(19) United States
(12) Patent Application Publication
(10) Pub. No.: US 2021/0160791 A1
(43) Pub. Date: May 27, 2021

(54) INFORMATION REPORTING METHOD AND DEVICE

(71) Applicant: ZTE Corporation, Shenzhen (CN)

(72) Inventors: Xiubin SHA, Shenzhen (CN); Bo DAI, Shenzhen (CN); Ting LU, Shenzhen (CN)

(21) Appl. No.: 16/632,778

(22) PCT Filed: Sep. 29, 2018
(86) PCT No.: PCT/CN2018/108810

§ 371 Date: Jan. 21, 2020

(30) Foreign Application Priority Data
Sep. 29, 2017 (CN) 201710908733.9

(51) Int. Cl. H04W 52/36; H04W 72/12; H04W 80/02

(52) U.S. Cl. CPC H04W 52/365; H04W 80/02; H04W 72/1284

(57) ABSTRACT

An information reporting method includes: sending a scheduling request (SR) to a base station; receiving an uplink scheduling authorization resource sent by the base station according to the SR; and sending power headroom report (PHR) information to the base station on the uplink scheduling authorization resource.

### CROSS REFERENCE

This application is the 371 application of PCT Application No. PCT/CN2018/108810 filed Sep. 29, 2018, which is based upon and claims priority to Chinese Patent Application No. 201710908733.9, filed on Sep. 29, 2017 the entire contents thereof are incorporated herein by reference.

### TECHNICAL FIELD

The present disclosure relates to the field of communication technologies, and more particularly, to an information reporting method and device.

### BACKGROUND

In the related art, a Buffer Status Report (BSR) and a Power Headroom Report (PHR) are important reference information for an eNB to perform reasonable radio resource scheduling for an UE.

The BSR is used by the UE to report the state of the data volume stored in its own buffer. A variety of BSR types and transmission rule are specified in the Long Term Evolution (LTE) system. Based on the event that triggered the BSR, the BSR is classified into three types: Regular BSR, Periodic BSR, and Padding BSR.

Wherein, the trigger condition of the Regular BSR can include the following three types.

In type (1), transmittable data of upper layer having high priority logical channel arrive, and its priority is higher than the existing LCH data in the UE buffer.

In type (2), there is change occurring in a serving cell.

In type (3), the BSR retransmission timer (RETX_BSR_TIMER) expires and there is data that can be transmitted in the UE buffer.

The trigger condition of the Periodic BSR may include that the periodic BSR is triggered if the Periodic BSR timer expires.

The trigger condition of the Padding BSR may include that, if there is neither a Regular BSR to be sent nor a Periodic BSR to be sent, and a number of bits used for padding in allocated uplink PUSCH resource is greater than or equal to sum of size of the BSR Medium Access Control (MAC) Control Element (CE) and its MAC subheader, the padding BSR is triggered.

The Padding BSR is a padded BSR that complements the Regular BSR and the Periodic BSR; in contrast, the Regular BSR and the Periodic BSR can be classified as unpadded BSRs. When the uplink does not send the Regular BSR and the Periodic BSR, the Padding BSR can make the eNB obtain LCG data change of the UE buffer in a timelier manner.

In addition, the carry ways of the Regular BSR, the Periodic BSR and the Padding BSR are different. The Regular BSR and the Periodic BSR are encapsulated as one MAC CE in the Media Access Control Protocol Data Unit (MAC PDU). The Padding BSR is carried in a Padding bit of the MAC PDU and is also encapsulated as a MAC CE. The only difference of three BSRs in the carry way is whether the padding bits are used. The MAC PDU is sent on the PUSCH.

The PHR means that the UE reports a difference value of the UE's nominal maximum transmit power and the estimated uplink shared channel (UL-SCH) transmit power to the eNB by means of the MAC CE. Difference

In the LTE system, the case of triggering the PHR may include the following three types.

In type 1, the prohibitPHR-Timer expires, and a change amount in path loss is greater than a set value (calculated from previous PHR).

In type 2, the periodicPHR-Timer expires.

In type 3, configuration or reconfiguration of PHR functional entities.

After the PHR is triggered, the UE performs PHR transmission when there is an uplink transmission resource supporting the PHR. FIG. 4 is a schematic diagram illustrating MAC CE format of a PHR based on the related art. As shown in FIG. 4, the Power Headroom (PH) bit domain indicates the power headroom in the PHR, and the PH bit domain has a length of 6 bits. In addition, there are two R bits reserved bits. The default value of these reserved bits is 0 in the related art.

In order to support machine type communication terminals (such as sensors, smart homes, smart grid monitoring, etc.), a narrowband air interface technology-Narrow Band Internet of Things (NB-IoT) is introduced to the existing LTE system, system bandwidth thereof is 180 kHz, which is specially used to carry machine type communication based on small flow data, so as to avoid the small data of massive machine type terminals affecting the spectral efficiency of the broadband LTE system, and increase the user capacity carried by the unit bandwidth.

However, deployment of the narrowband systems can isolate both machine type and non-machine type terminals, but in terms of the narrowband system itself, it does not improve the efficiency of data transmission on user plane, because, like the broadband system, the control plane overhead of the narrowband system and the data transmission mechanism use a mechanism similar to that of broadband LTE., so the spectral efficiency of the entire narrowband system is not significantly improved compared with the LTE system.

In view of the above problems in the related art, no effective solution has been found yet.

### SUMMARY

The embodiment of the disclosure provides an method and a device for information reporting, which at least solves the defects of the PHR reporting mechanism in the related art, and satisfies the requirement of acquiring related information in the NB-IoT system.

Based on an embodiment of present disclosure, an information reporting method is provided, including: sending a scheduling request SR to a base station; receiving an uplink scheduling grant resource sent by the base station based on the SR; and sending power headroom report PHR information to the base station on the uplink scheduling grant resource.

Based on an embodiment of present disclosure, another information reporting method is provided, including: sending a scheduling request SR to a base station; receiving an uplink scheduling grant resource sent by the base station based on the SR; and transmitting data to the base station on the uplink scheduling grant resource.

Based on an embodiment of present disclosure, another information reporting method is provided, including: receiving a scheduling request SR sent by a terminal; sending an uplink scheduling grant resource to the terminal based on the SR; and receiving data transmitted by the terminal on the uplink scheduling grant resource.

Based on an embodiment of present disclosure, another information reporting method is provided, including: determining status of a buffer status report BSR; obtaining a value range of the BSR based on the status; and reporting the BSR to the base station by using the value range.

Based on an embodiment of present disclosure, another information reporting method is provided, including: receiving system information sent by a base station, wherein the system information carries one of: extend power headroom PH support indication, extend data volume and power headroom report DPR support indication; and reporting PH to the base station based on the system information.

Based on an embodiment of present disclosure, another information reporting method is provided, including: sending system information to a terminal, wherein the system information carries one of: extend power headroom PH support indication, extend data volume and power headroom report DPR support indication; and receiving a PH reported by the terminal based on the system information.

Based on another embodiment of present disclosure, an information reporting device is provided, including: a first sending module, configured to send a scheduling request SR to a base station; a receiving module, configured to receive an uplink scheduling grant resource transmitted by the base station based on the SR; and a second sending module, configured to send power headroom report PHR information to the base station on the uplink scheduling grant resource.

Based on another embodiment of present disclosure, another information reporting device is provided, including: a sending module, configured to send a scheduling request SR to a base station; a receiving module, configured to receive an uplink scheduling grant resource sent by the base station based on the SR; and a transmission module, configured to transmit data to the base station on the uplink scheduling grant resource.

Based on another embodiment of present disclosure, another information reporting device is provided, including: a first receiving module, configured to receive a scheduling request SR sent by a terminal; a sending module, configured to send an uplink scheduling grant resource to the terminal based on the SR; and a second receiving module, configured to receive data transmitted by the terminal on the uplink scheduling grant resource.

Based on another embodiment of present disclosure, another information reporting device is provided, including: a determination module, configured to determine status of a buffer status report BSR; an obtaining module, configured to obtain a value range of the BSR based on the status; and a reporting module, configured to report the BSR to the base station by using the value range.

Based on another embodiment of present disclosure, another information reporting device is provided, including: a receiving module, configured to receive system information sent by a base station, wherein the system information carries one of: extend power headroom PH support indication, extend data volume and power headroom report DPR support indication; and a reporting module, configured to report PH to the base station based on the system information.

Based on another embodiment of present disclosure, another information reporting device is provided, including: a sending module, configured to send system information to a terminal, wherein the system information carries one of: extend power headroom PH support indication, extend data volume and power headroom report DPR support indication; and a receiving module, configured to receive a PH reported by the terminal based on the system information.

Based on another embodiment of present disclosure, a storage medium is provided, the storage medium is configured to store program code for performing the following steps:

sending a scheduling request SR is sent to a base station;

receiving an uplink scheduling grant resource sent by the base station based on the SR; and

sending power headroom report PHR information to the base station on the uplink scheduling grant resource.

Aiming at the defect that the granularity of partial reporting information in the PHR is too large in the related art, and the value range is too small, the disclosure solves the defects of the PHR reporting mechanism in the related art, and satisfies the requirement of acquiring the related information in the NB-IoT system.

### BRIEF DESCRIPTION OF THE DRAWINGS

The drawings described herein are intended to provide a further understanding of the disclosure, and are intended to be a part of the disclosure. The illustrative embodiments of the present disclosure and the description thereof are intended to explain the present disclosure and are not intended to limit the disclosure. In the drawing,

FIG. 1 is a flow chart 1 illustrating an information reporting method based on an embodiment of the present disclosure;

FIG. 2 is a flow chart 2 illustrating an information reporting method based on an embodiment of the present disclosure;

FIG. 3 is a flow chart 3 illustrating an information reporting method based on an embodiment of the present disclosure;

FIG. 4 is a flow chart 4 illustrating an information reporting method based on an embodiment of the present disclosure;

FIG. 5 is a flow chart 5 illustrating an information reporting method based on an embodiment of the present disclosure;

FIG. 6 is a schematic diagram illustrating PHR reporting triggered by SR carried on PRACH of the present embodiment;

FIG. 7 is a schematic diagram illustrating PHR reporting triggered by SR carried on dedicated SR resource of the present embodiment;

FIG. 8 is a schematic diagram illustrating small data scheduling request indication or data volume level of small data scheduling request reported by a scheduling request SR of the present embodiment;

FIG. 9 is a schematic diagram illustrating a big data scheduling request reported by a scheduling request SR of the present embodiment;

FIG. 10 is a schematic structural diagram illustrating a MAC CE of a DPR of the present embodiment;

FIG. 11 is a schematic structural diagram 1 illustrating a DPR MAC CE of an extend PH according to the embodiment;

FIG. 12 is a schematic structural diagram 2 illustrating a DPR MAC CE of an extend PH according to the embodiment;

FIG. 13 is a schematic structural diagram 3 illustrating a DPR MAC CE of an extend PH according to the embodiment;

FIG. 14 is a schematic structural diagram 4 illustrating a DPR MAC CE of an extend PH according to the embodiment;

FIG. 15 is a flow chart illustrating a use example of extend DPR of the present embodiment;

FIG. 16 is a schematic structural diagram illustrating hardware components of an electronic device based on an embodiment of the present disclosure.

### DETAILED DESCRIPTION

The disclosure will be described in detail below with reference to the drawings in conjunction with the embodiments. It should be noted that the embodiments in the present application and the features in the embodiments may be combined with each other without conflict.

It is to be understood that the terms “first”, “second”, and the like in the specification and claims of the present disclosure are used to distinguish similar objects, and are not necessarily used to describe a particular order or order.

### The First Embodiment

The network architecture of the embodiment of the present application includes: a terminal UE and a base station (such as an eNB), wherein the terminal performs information interaction with the base station.

In an embodiment, an information reporting method is provided. FIG. 1 is a flow chart 1 illustrating an information reporting method based on an embodiment of the present disclosure. As shown in FIG. 1, the process includes the following steps S102-S106.

In step S102, an SR is sent to a base station.

In step S104, uplink scheduling grant resource sent by the base station based on the SR is received.

In step S106, PHR information is sent to the base station on the uplink scheduling grant resource.

Through the above steps, aiming at the defect that the granularity of partial reporting information in the PHR is too large in the related art, and the value range is too small, the disclosure solves the defects of the PHR reporting mechanism in the related art, and satisfies the requirement of acquiring the related information in the NB-IoT system.

Optionally, the execution subject of the above steps may be a terminal or the like, but is not limited thereto.

Optionally, the sending a scheduling request SR to a base station includes one of: sending the SR to the base station by dedicated SR resource; sending the SR to the base station by physical random access channel PRACH process; and sending the SR to the base station by joint transmission of acknowledgement (ACK)/non-acknowledgement (NACK).

Optionally, the PHR information is carried by one way of: DPR, extend DPR, and dedicated media access control MAC control element CE carrying PHR.

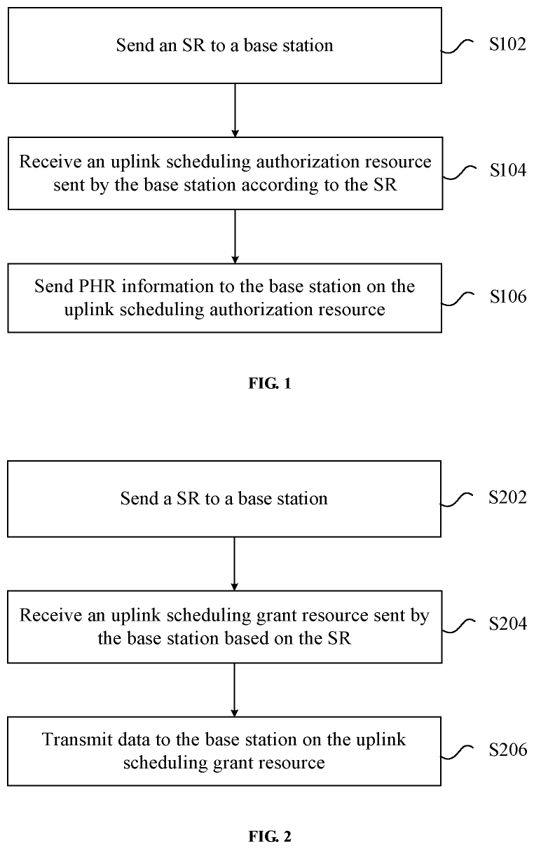

In an embodiment, another information reporting method is provided. FIG. 2 is a flow chart 2 illustrating an information reporting method based on an embodiment of the present disclosure. As shown in FIG. 2, the process includes the following steps S202-S206.

In step S202, a scheduling request SR is sent to a base station.

In step S204, an uplink scheduling grant resource sent by the base station based on the SR is received.

In step S206, data is transmitted to the base station on the uplink scheduling grant resource.

In some embodiments, the execution subject of the above steps may be a terminal or the like, but is not limited thereto.

In some embodiments, dedicated SR includes one of: small data scheduling request indication or data volume level of small data scheduling request; and big data scheduling request indication.

In some embodiments, the transmitting data to the base station on the uplink scheduling grant resource includes: transmitting, when the SR includes the small data scheduling request indication or the data volume level of the small data scheduling request, the small data to the base station on the uplink scheduling grant resource; and transmitting, when the SR includes the big data scheduling request indication, at least one of the following to the base station: a buffer status report BSR, the BSR and the data.

In some embodiments, prior to the sending a scheduling request SR to a base station, the method further includes one of the following information.

At least one of the following information sent by the base station is received: the small data scheduling request support indication carried by the SR, data volume level support indication of the small data scheduling request carried by the SR, and the big data scheduling request support indication carried by the SR; and specifically received by one of the following ways: a RRC signaling, a MAC CE, and system broadcast information, wherein the system broadcast information includes system information block information or main system information block MIB information.

At least one of the following implicit indications by distinguishing between a threshold of data volume of the small and a big data or a threshold of data volume of the small data is obtained: the small data scheduling request support indication carried by the SR, the data volume level support indication of the small data scheduling request carried by the SR, and the big data scheduling request support indication carried by the SR.

The UE is carried on the SR only when it is supported by the base station: the small data scheduling request indication, the data volume level of the small data scheduling request, and the big data scheduling request, thereby completing the friendly negotiation and interaction between the base station and the terminal.

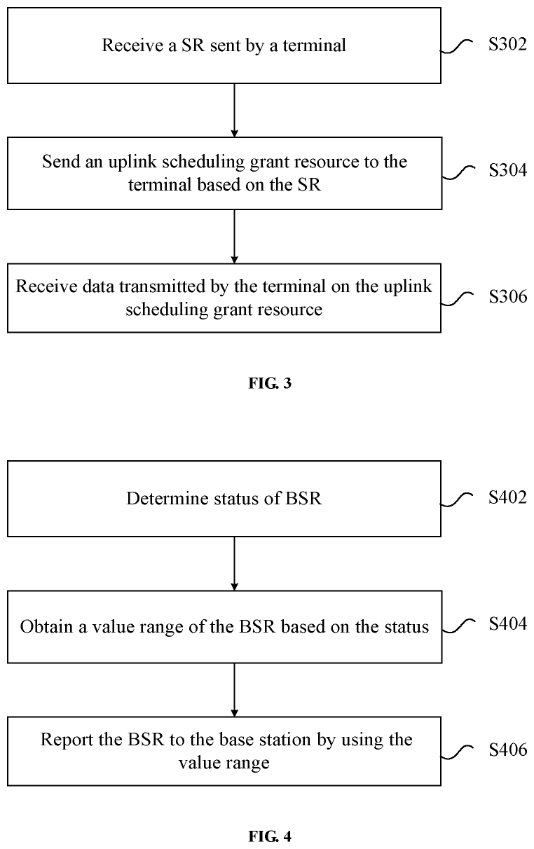

In an embodiment, another information reporting method is provided. FIG. 3 is a flow chart 3 illustrating an information reporting method based on an embodiment of the present disclosure. As shown in FIG. 3, the process includes the following steps S302-S306.

In step S302, a scheduling request SR sent by a terminal is received;

In step S304, an uplink scheduling grant resource is sent to the terminal based on the SR.

In step S306, data transmitted by the terminal on the uplink scheduling grant resource is received.

Optionally, the execution subject of the above steps may be a terminal or the like, but is not limited thereto.

In some embodiments, the SR includes one of: small data scheduling request indication or data volume level of small data scheduling request; and big data scheduling request indication.

In some embodiments, the sending an uplink scheduling grant resource to the terminal based on the SR includes steps S11-S12.

In step S11, the SR is parsed.

In step S12, when the SR includes the small data scheduling request indication or the data volume level of the small data scheduling request, the uplink scheduling grant resource required for transmitting small data is sent to the terminal; when the SR includes the big data scheduling request indication, one of following information is sent to the terminal: the uplink scheduling grant resource required for transmitting a buffer status report BSR, and the uplink scheduling grant resource required for transmitting the BSR and the data.

In some embodiments, prior to the receiving a scheduling request SR sent by a terminal, the method further includes one of the following information.

One of following information is sent to the terminal: small data scheduling request support indication carried by the SR, data volume level support indication of the small data scheduling request carried by the SR, and big data scheduling request support indication carried by the SR; and specifically sent to one of the following ways: a RRC signaling, a MAC CE, and system broadcast information, wherein the system broadcast information includes SIB information or main system information block MIB information.

At least one of the following implicit indications is indicated by distinguishing between a threshold of data volume of the small and a big data or a threshold of data volume of the small data: the small data scheduling request support indication carried by the SR, the data volume level support indication of the small data scheduling request carried by the SR, and the big data scheduling request support indication carried by the SR.

In an embodiment, another information reporting method is provided. FIG. 4 is a flow chart 4 illustrating an information reporting method based on an embodiment of the present disclosure. As shown in FIG. 4, the process includes the following steps S402-S406.

In step S402, status of a buffer status report BSR is determined.

In step S404, a value range of the BSR based on the status is obtained.

In step S406, the BSR is reported to the base station by using the value range.

Optionally, the execution subject of the above steps may be a terminal or the like, but is not limited thereto.

In some embodiments, the status of the BSR includes one of: a physical random access channel (PRACH) phase, RRC connection signaling phase data transmission, idle state, a non-orthogonal multiple access (NOMA) phase.

In some embodiments, prior to the obtaining a value range of the BSR based on the status, the method further includes: defining the value range in different states by at least one of the following policies: reducing reporting range of buffer size value, increasing reporting granularity of the buffer size value, or increasing buffer size interval within the same buffer size index, and defining based on transmitted block size in small data transmission state.

In an embodiment, another information reporting method is provided. FIG. 5 is a flow chart 5 illustrating an information reporting method based on an embodiment of the present disclosure. As shown in FIG. 5, the process includes the following steps S502-S504.

In step S502, system information sent by a base station is received, wherein the system information carries one of: extend PH support indication, and extend DPR support indication.

In step S504, PH is reported to the base station based on the system information.

Optionally, the execution subject of the above steps may be a terminal or the like, but is not limited thereto.

In an embodiment, the system information includes one of: SIB information, and MIB information.

In an embodiment, the reporting PH to the base station based on the system information includes one of the following information.

When extend DPR support indication is carried by the system information and DPR extend is supported by a terminal, the PH is reported by using MAC CE format of the extend DPR.

When the extend DPR support indication is not carried by the system information, or extend of DPR being not supported by the terminal, or DPR extend is undesirable for the terminal, the PH is reported by using the MAC CE format of DPR.

In an embodiment, when PH is reported to the base station based on the system information, the method further includes one of following information.

RRC message is sent to the base station, wherein the RRC message carries the extend DPR support indication.

MAC CE indication information is sent to the base station, wherein the indication information carries the extend DPR support indication or extend DPR unsupported indication.

In an embodiment, when the PH is reported by using the MAC CE format of DPR, structure of the MAC CE further includes one of the following information.

In the MAC CE, rightmost 4 bits are used to indicate the data volume level DV, and adjacent 3 bits are used to indicate the extend PH, and leftmost 1 bit is used to indicate whether the DPR is the DPR after the PH extend or the DPR before the PH extend, or indicate support capability of the extend DPR.

In the MAC CE, the rightmost 4 bits are used to represent the DV, and adjacent 2 bits are used to represent PH domain. Leftmost 2 reserved bits are used to indicate whether PH value is extended and section of the PH value.

In the MAC CE, the rightmost 4 bits are used to represent the DV, and leftmost 4 bits are used to represent the PH.

In the MAC CE, the rightmost 4 bits are used to represent the DV, and adjacent 2 bits thereof are used to indicate the PH domain, and 1 bit of leftmost 2 bits is used to indicate whether the PH field in the DPR is valid, or indicate the support capability of the extend DPR, 1 bit left can be reserved.

The embodiment further provides an information reporting method, including: sending system information to a terminal, wherein the system information carries one of: extend PH support indication, and DPR support indication; a PH reported by the terminal based on the system information is received.

Optionally, the execution subject of the above steps may be a terminal or the like, but is not limited thereto.

In an embodiment, the system information includes one of: SIB information, and MIB information.

Through the description of the above embodiments, those skilled in the art can clearly understand that the method based on the above embodiment can be implemented by means of software plus a necessary general hardware platform, and of course, by hardware, but in many cases, the former is a better implementation. Based on such understanding, the substance of the technical solution of the present disclosure, or the portion of the disclosure that makes contribution to the state of the art, may be embodied in the form of a software product stored in a storage medium (such as ROM/RAM, disk, the optical disc), and it include several instructions for causing a terminal device (which may be a cell phone, a computer, a server, or a network device, etc.) to perform the methods described in various embodiments of the present disclosure.

### The Second Embodiment

An information reporting device is also provided in an embodiment. The device is used to implement the foregoing embodiments and preferred embodiments, and details are not described herein. As used below, the term “module” may implement a combination of software and/or hardware of a predetermined function. Although the devices described in the following embodiments are preferably implemented in software, hardware, or a combination of software and hardware, is also possible and contemplated.

An information reporting device is provided in an embodiment, including: a first sending module, configured to send a SR to a base station; a receiving module, configured to receive an uplink scheduling grant resource transmitted by the base station based on the SR; and a second sending module, configured to send PHR information to the base station on the uplink scheduling grant resource.

Another information reporting device is provided in an embodiment, including: a sending module, configured to send a SR to a base station; a receiving module, configured to receive an uplink scheduling grant resource sent by the base station based on the SR; and a transmission module, configured to transmit data to the base station on the uplink scheduling grant resource.

Another information reporting device is provided in an embodiment, including: a first receiving module, configured to receive a SR sent by a terminal; a sending module, configured to send an uplink scheduling grant resource to the terminal based on the SR; and a second receiving module, configured to receive data transmitted by the terminal on the uplink scheduling grant resource.

Another information reporting device is provided in an embodiment, including: a determination module, configured to determine status of a status report BSR; a obtaining module, configured to obtain a value range of the BSR based on the status; and a reporting module, configured to report the BSR to the base station by using the value range.

Another information reporting device is provided in an embodiment, including: a receiving module, configured to receive system information sent by a base station, wherein the system information carries one of: extend PH support indication, extend DPR support indication; and a reporting module, configured to report PH to the base station based on the system information.

Another information reporting device is provided in an embodiment, including: a sending module, configured to send system information to a terminal, wherein the system information carries one of: extend PH support indication, extend DPR support indication; and a receiving module, configured to receive a PH reported by the terminal based on the system information.

It should be noted that each of the above modules may be implemented by software or hardware. For the latter, it may be implemented by the following ways, but not limited to this, the above modules are all located in the same processor; or, the above modules are respectively located in different processors in any combination.

### The Third Embodiment

This embodiment is an optional embodiment of the present application, and is used to describe the application in detail with reference to specific examples.

In order to improve the transmission efficiency of the narrowband system and reduce the signaling overhead, the BSR of the NBIOT system and PHR reporting mechanisms are optimized.

It is considered that the service demand of the NB-IoT system is mainly for the transmission of smaller data packets, the PHR mechanism is simplified: the DPR being carried by the UE in the Msg3, which includes the buffer data volume and the UE power headroom.

When the UE has the uplink grant resource, the BSR information can be reported through the Regular BSR, the Periodic BSR, and the Padding BSR mechanism.

When the UE does not have uplink scheduling resources and needs to send uplink data, the uplink SR is initiated by the PRACH process.

In addition, other ways of reporting of PHR and BSR are not supported.

In this way, when the UE stays in the connection mode for a long time or the UE causes the ECL to change due to factors such as mobility and changes in the radio environment, the UE cannot obtain the PHR information in time; when the UE does not have the uplink scheduling resource, the UE cannot obtain the BSR information in time.

In addition, transmission of small data services in the PRACH phase is considered in the LTE system including NB-IoT, and the data volume that can be carried in the PRACH phase, due to the limitation of the message size, is limited, and the transmitted data volume in the RRC connected state is not an order of magnitude; in addition, the BSR carry mode in the PRACH phase results in a limited granularity of the BSR (possibly using Preamble grouping, or using fewer bits to represent the different data volume in the Buffer.). Therefore, the value range of BSR using connected state and reporting strategy are not suitable. An inactive state and NOMA access phase also have similar problem. At present, the PHR can only be carried by the DPR information carried in the Msg3, wherein the PH part only occupies 2 bits, and can express 4 values. The granularity of partial reporting information in the PHR is too large in the related art, and the value range is too small.

In summary, the BSR and PHR reporting mechanisms in the NB-IoT system are flawed and cannot satisfy the requirement of acquiring the related information in the NB-IoT system.

The present disclosure proposes a solution to the shortcomings of the BSR and PHR reporting strategies in the NB-IoT system.

The defects of current NB-IoT system BSR and PHR reporting mechanism is solved by introducing new PHR and BSR reporting mechanisms and reporting formats.

The scheme of this embodiment may be embodied as follows.

The PHR is reported after the dedicated SR.

Two-level BSR includes: the small data scheduling request indication carried by the SR or the data volume level of the small data scheduling request, and the big data scheduling request indication; if the big data scheduling request indication is carried, the data volume is reported through the further BSR or BSR+Data.

The BSR defines different value ranges and/or value intervals for different states.

The PH value granularity and value range in DPR is extended.

The extend PH or extend DPR support indication is added to system information to maintain backward compatibility.

The UE extends PH or the extend DPR support capability or use indication reporting strategies to maintain backward compatibility.

The MAC CE format of the extend DPR is introduced (which can be called the DPR MAC CE format of the extend PH).

Scheme 1: The PHR is Reported after the SR

The UE sends an SR scheduling request to the eNodeB; the SR scheduling request may be carried by the dedicated SR resource, or jointly transmitted with the ACK/NACK, and the SR transmission way in other physical layers.

The eNodeB sends the uplink scheduling grant to the UE.

The UE sends the PHR information on the uplink scheduling grant resource of the eNodeB, the PHR information can be carried in one of the following ways: DPR, extend DPR (see scheme 4), or a dedicated MAC CE carrying the PHR.

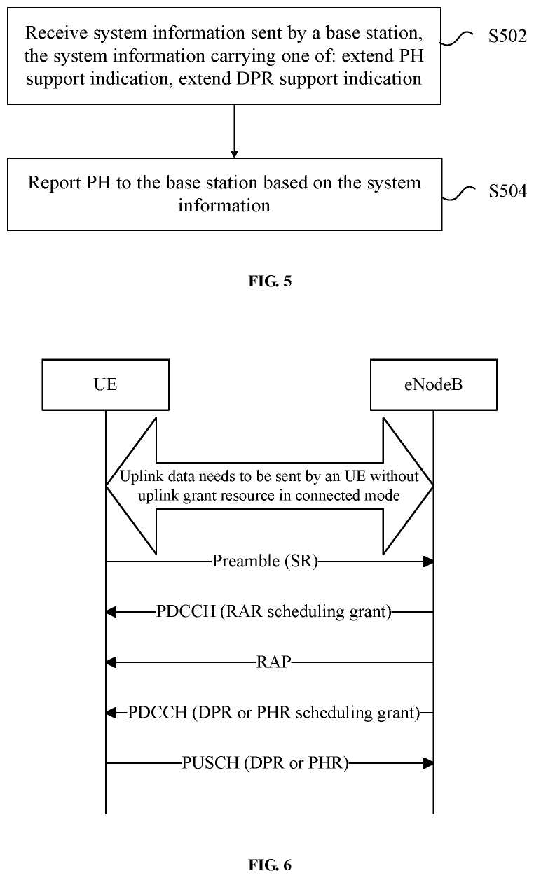

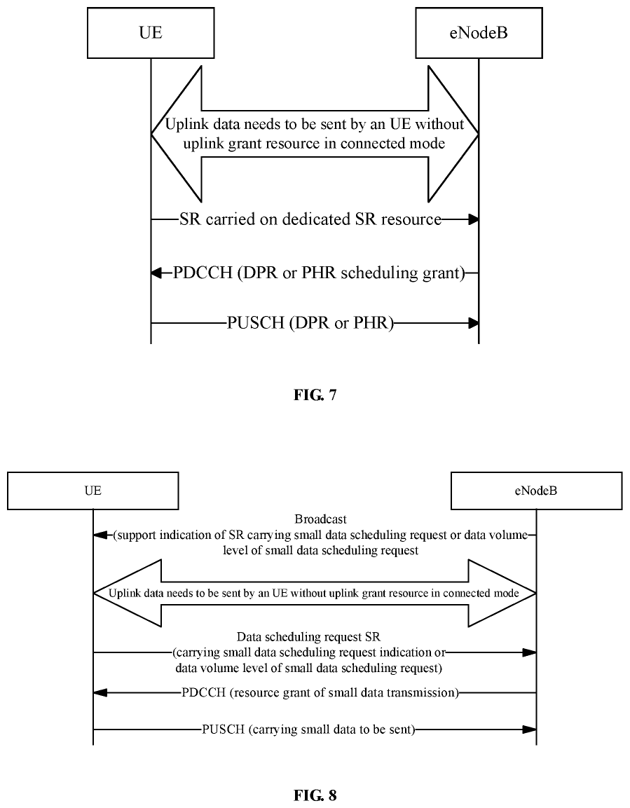

FIG. 6 is a schematic diagram illustrating PHR reporting triggered by SR carried on PRACH of the present embodiment, FIG. 7 is a schematic diagram illustrating PHR reporting triggered by SR carried on dedicated SR resource of the present embodiment.

Scheme 2: Two-Level BSR

The UE sends a dedicated SR to the eNodeB (which may be dedicated or non-dedicated, the following content is described by taking a dedicated SR as an example); the dedicated SR includes two parts of information: small data scheduling request indication or data volume level of the small data scheduling request, big data scheduling request indication. (different from the prior art)

For example, when the dedicated SR contains 1 bit, the value 0 means small data transmission; the value 1 means big data transmission.

Optionally, the dedicated SR contains 2 bits, the values 0, 1 and 2 indicates that the data volume levels of the small data scheduling request are 0, land 2, respectively; the value 3 indicates the big data scheduling request indication.

The eNodeB sends an uplink scheduling grant to the UE based on the dedicated SR. The method for determining the uplink grant is described as follows.

If the small data scheduling request indication or the data volume level of the small data scheduling request is indicated in the dedicated SR, the uplink grant resource is the resource required for the transmission of the small data; at this time, the uplink grant resource does not need to report the BSR.

If the big data scheduling request indication is indicated in the dedicated SR, the uplink grant resource is the resource required for reporting the BSR, and/or the resource of the BSR resource and the size of the predefined data packet. In this case, the BSR needs to be reported in the uplink grant resource, wherein the BSR value can be indicated for the value range corresponding to the big data.

FIG. 8 is a schematic diagram illustrating small data scheduling request indication or data volume level of small data scheduling request reported by a scheduling request SR of the present embodiment.

The small data scheduling request support indication or the data volume level support indication of the small data scheduling request carried by SR may also be implicitly indicated by a threshold of data volume of the small data or a threshold of data volume level of the small data.

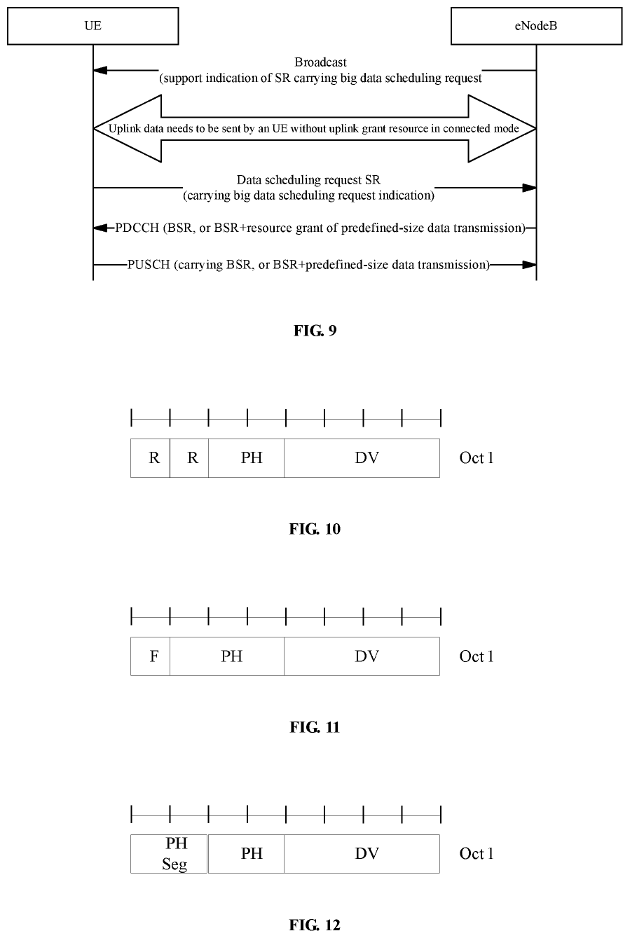

FIG. 9 is a schematic diagram illustrating a big data scheduling request reported by a scheduling request SR of the present embodiment. The big data scheduling request support indication carried by SR may also be implicitly indicated by the data volume threshold of the big data.

Scheme 3: Different Ranges is Defined by the BSR for Different States

For the BSR report in the connected state, the value of the BSR is shown in Table 1.

TABLE 1
Buffer size levels for BSR in connected
mode (buffer size levels of Buffer )

| | Buffer Size (BS) |
|---|---|
| Index | value [bytes] |
| 0 | BS = 0 |
| 1 | 0 < BS <= 10 |
| 2 | 10 < BS <= 12 |
| 3 | 12 < BS <= 14 |
| 4 | 14 < BS <= 17 |
| 5 | 17 < BS <= 19 |
| 6 | 19 < BS <= 22 |
| 7 | 22 < BS <= 26 |
| 8 | 26 < BS <= 31 |
| 9 | 31 < BS <= 36 |
| 10 | 36 < BS <= 42 |
| 11 | 42 < BS <= 49 |
| 12 | 49 < BS <= 57 |
| 13 | 57 < BS <= 67 |
| 14 | 67 < BS <= 78 |
| 15 | 78 < BS <= 91 |
| 16 | 91 < BS <= 107 |
| 17 | 107 < BS <= 125 |
| 18 | 125 < BS <= 146 |
| 19 | 146 < BS <= 171 |
| 20 | 171 < BS <= 200 |
| 21 | 200 < BS <= 234 |
| 22 | 234 < BS <= 274 |
| 23 | 274 < BS <= 321 |
| 24 | 321 < BS <= 376 |
| 25 | 376 < BS <= 440 |
| 26 | 440 < BS <= 515 |
| 27 | 515 < BS <= 603 |
| 28 | 603 < BS <= 706 |
| 29 | 706 < BS <= 826 |
| 30 | 826 < BS <= 967 |
| 31 | 967 < BS <= 1132 |
| 32 | 1132 < BS <= 1326 |
| 33 | 1326 < BS <= 1552 |
| 34 | 1552 < BS <= 1817 |
| 35 | 1817 < BS <= 2127 |
| 36 | 2127 < BS <= 2490 |
| 37 | 2490 < BS <= 2915 |
| 38 | 2915 < BS <= 3413 |
| 39 | 3413 < BS <= 3995 |
| 40 | 3995 < BS <= 4677 |
| 41 | 4677 < BS <= 5476 |
| 42 | 5476 < BS <= 6411 |
| 43 | 6411 < BS <= 7505 |
| 44 | 7505 < BS <= 8787 |
| 45 | 8787 < BS <= 10287 |
| 46 | 10287 < BS <= 12043 |
| 47 | 12043 < BS <= 14099 |
| 48 | 14099 < BS <= 16507 |
| 49 | 16507 < BS <= 19325 |
| 50 | 19325 < BS <= 22624 |
| 51 | 22624 < BS <= 26487 |
| 52 | 26487 < BS <= 31009 |
| 53 | 31009 < BS <= 36304 |
| 54 | 36304 < BS <= 42502 |
| 55 | 42502 < BS <= 49759 |
| 56 | 49759 < BS <= 58255 |
| 57 | 58255 < BS <= 68201 |
| 58 | 68201 < BS <= 79846 |
| 59 | 79846 < BS <= 93479 |
| 60 | 93479 < BS <= 109439 |
| 61 | 109439 < BS <= 128125 |
| 62 | 128125 < BS <= 150000 |
| 63 | BS > 150000 |

For the PRACH phase, the data early, Inactive state, and/or the NOMA access phase, and the like of the small data transmission state, due to the limitation of the BSR carry way and the relatively small volume of transmitted data, use a new BSR value list different from the traditional Legacy BSR (see Table 1) at this stage. Strategy of the new BSR list value generation includes at least one of the following ways.

The reporting range of the Buffer Size value is reduced, for example, very small, and/or particularly large Buffer Size value is no longer reported. (see Table 2: BS value less than 78 and greater than 706 is no longer perform subdivision granularity)

The reporting granularity of the Buffer Size value is increased or the Buffer Size interval in the same Buffer Size Index is increased. (see Table 2: The Buffer Size range corresponding to the same Buffer Size Index is larger than that of Table 1.)

A new BSR value list is regenerated based on transmitted block size in small data transmission state.

TABLE 2
Buffer size levels for BSR in small data transmission

| | Buffer Size (BS) |
|---|---|
| Index | value [bytes] |
| 0 | BS < 78 |
| 1 | 76 < BS <= 146 |
| 2 | 146 < BS <= 200 |
| 3 | 200 < BS <= 274 |
| 4 | 274 < BS <= 376 |
| 5 | 376 < BS <= 515 |
| 6 | 515 < BS <= 706 |
| 7 | 706 < BS |

In some embodiments, some small values may not be reported, especially small, and one data packet may be transmitted, and the interval may be larger, for example, the first 32 values of the original BSR table are compressed into 8 values.

Scheme 4: PH Value Granularity and Value Range in DPR is Extended

An extend PH or extend DPR support indication is added to the system information. The system information may be SIB or MIB information (different from the prior art).

The UE reports its extend PH or extend DPR support indication. The UE may report its extend PH or extend DPR support indication in one of the following ways.

It is reported by the MAC CE (for example, it is reported by the reserved bit redefinition of DPR MAC CE)

It is reported by an RRC message, the RRC message includes RRCConnectionRequest-NB and/or RRCConnectionResumeRequest-NB.

When the cell supports extend PH or extend DPR support, and the UE also supports the extend PH or the extend DPR, the PH is reported by using the extend PH or the MAC CE of the extend DPR.

FIG. 10 is a schematic structural diagram illustrating a MAC CE of a DPR of the present embodiment. In FIG. 10, this embodiment is the MAC CE structure of the DPR in the current standard.

Wherein, the rightmost 4 bits are used to represent DV (Data Volume Level)

The next 2 bits are used to represent the PH (Power Headroom Level), and its value corresponds to Table 3.

The leftmost 2 bits are temporarily reserved.

Since the PH occupies 2 bits, the PH has only 4 values (see Table 3), and the granularity of the power headroom (PH) is insufficient.

TABLE 3
Power Headroom levels for PH

| PH | Power Headroom Level |
|---|---|
| 0 | POWER_HEADROOM_0 |
| 1 | POWER_HEADROOM_1 |
| 2 | POWER_HEADROOM_2 |
| 3 | POWER_HEADROOM_3 |

The MAC CE format of the extend DPR (which may be referred to as the DPR MAC CE format of the extend PH) is introduced, as shown in FIGS. 11, 12, 13, and 14.

FIG. 11 is a schematic structural diagram 1 illustrating a DPR MAC CE of an extend PH according to the embodiment. This embodiment is a DPR MAC CE structure after the PH extend in the current standard.

Wherein, the rightmost 4 bits are used to represent DV (Data Volume Level)

The next 3 bits are used to represent the PH (Power Headroom Level), and values thereof correspond to Table 3.

The leftmost 1 bit is used to indicate whether the DPR is the DPR after the PH extend or the DPR before the PH extend (in the current standard), or indicate support capability of the extend DPR.

TABLE 4
Power Headroom levels for PH after extend

| PH | Power Headroom Level |
|---|---|
| 0 | POWER_HEADROOM_0 |
| 1 | POWER_HEADROOM_1 |
| 2 | POWER_HEADROOM_2 |
| 3 | POWER_HEADROOM_3 |
| 4 | POWER_HEADROOM_4 |
| 5 | POWER_HEADROOM_5 |
| 6 | POWER_HEADROOM_6 |
| 7 | POWER_HEADROOM_7 |

FIG. 12 is a schematic structural diagram 2 illustrating a DPR MAC CE of an extend PH according to the embodiment. This embodiment is a DPR MAC CE structure after the PH extend in the current standard.

Wherein, the rightmost 4 bits are used to represent DV (Data Volume Level)

The next 2 bits are used to represent the PH (Power Headroom Level) domain.

Leftmost 2 reserved bits are used to indicate whether PH value is extended and section of the PH value. (It implicitly extends the support capabilities of DPR), (values thereof correspond to Table 5.)

When the leftmost bit takes a value of 0; the PH domain is the PH value of Legacy (the PH value does not extend).

When the leftmost bit takes a value of 1; the PH domain is the PH interval 1 after extend (the PH value does not extend).

When the leftmost bit takes a value of 2; the PH domain is the PH interval 2 after extend (the PH value does not extend).

When the leftmost bit takes a value of 3; the PH domain is the PH interval 3 after extend (the PH value does not extend).

TABLE 5
Power Headroom levels for PH after extend

| PH Seg | PH | Power Headroom Level |
|---|---|---|
| 1 | 0 | POWER_HEADROOM_0 |
| | 1 | POWER_HEADROOM_1 |
| | 2 | POWER_HEADROOM_2 |
| | 3 | POWER_HEADROOM_3 |
| 2 | 4 | POWER_HEADROOM_4 |
| | 5 | POWER_HEADROOM_5 |
| | 6 | POWER_HEADROOM_6 |
| | 7 | POWER_HEADROOM_7 |
| 3 | 8 | POWER_HEADROOM_8 |
| | 9 | POWER_HEADROOM_9 |
| | 10 | POWER_HEADROOM_10 |
| | 11 | POWER_HEADROOM_11 |

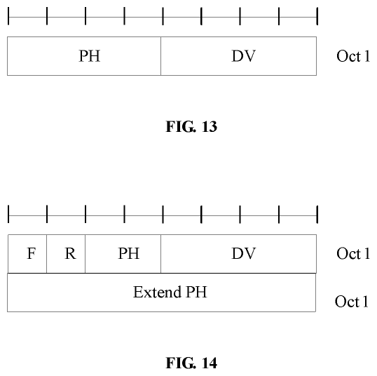

FIG. 13 is a schematic structural diagram 3 illustrating a DPR MAC CE of an extend PH according to the embodiment. This embodiment is a DPR MAC CE structure after the PH extend in the current standard.

Wherein, the rightmost 4 bits are used to represent DV (Data Volume Level)

The leftmost 4 bits are used to represent the PH (Power Headroom Level). (values thereof correspond to Table 6)

In an embodiment, the RRC message or other MAC CE is required to carry an indication of whether the UE uses the extend PH or the extend DPR; if yes, the PH value is reported in the MAC CE format of the extend PH or the extend DPR; otherwise, the MAC CE format of the legacy is used to the PH value reporting.

TABLE 6
Power Headroom levels for PH after extend

| PH | Power Headroom Level |
|---|---|
| 0 | POWER_HEADROOM_0 |
| 1 | POWER_HEADROOM_1 |
| 2 | POWER_HEADROOM_2 |
| 3 | POWER_HEADROOM_3 |
| 4 | POWER_HEADROOM_4 |
| 5 | POWER_HEADROOM_5 |
| 6 | POWER_HEADROOM_6 |
| 7 | POWER_HEADROOM_7 |
| 8 | POWER_HEADROOM_8 |
| 9 | POWER_HEADROOM_9 |
| 10 | POWER_HEADROOM_10 |
| 11 | POWER_HEADROOM_11 |
| 12 | POWER_HEADROOM_12 |
| 13 | POWER_HEADROOM_13 |
| 14 | POWER_HEADROOM_14 |
| 15 | POWER_HEADROOM_15 |

FIG. 14 is a schematic structural diagram 4 illustrating a DPR MAC CE of an extend PH according to the embodiment. This embodiment is a DPR MAC CE structure after the PH extend in the current standard.

Wherein, the rightmost 4 bits are used to represent DV (Data Volume Level)

The next 2 bits are used to represent the PH (Power Headroom Level) domain.

The leftmost 2 bits are used to indicate whether the PH field in the DPR is valid, or indicate the support capability of the extend DPR. If the value of the bit is 1, the PH domain in the DPR is invalid; it indicates the PH value is extended and need to use the DPR format of the extend PH or the dedicated MAC CE carrying the PHR to reporting.

When the system message received by the UE includes the extend DPR support indication, and the UE supports the extend DPR and is desirable to use the extend DPR, the PH is reported in the MAC CE format of the extend DPR.

When the system message received by the UE does not include the extend DPR support indication, or extend DPR is not supported by the UE, or DPR extend is undesirable for the UE, the PH is reported in the MAC CE format of regular DPR.

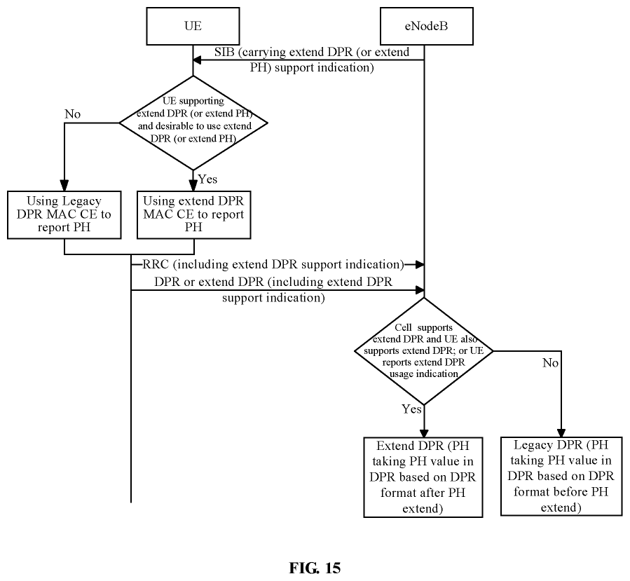

After the DPR is received by the eNodeB, if the cell supports the extend DPR and the UE also supports the extend DPR, or the UE indicates that the extend DPR is used, it is considered that the DPR information is received according to the MAC CE format of the extend DPR; otherwise, the DPR information is received according to the MAC CE format of regular DPR. FIG. 15 is a flow chart illustrating a use example of extend DPR of the present embodiment.

In the present embodiment, an extend PH or extend DPR support indication is added to system information. The system information may be SIB or MIB information.

When the system information received by an UE includes the extend DPR support indication, and the UE supports the extend DPR and is desirable to use the extend DPR, the PH is reported in the MAC CE format of the extend DPR.

When the system information received by an UE does not include the extend DPR support indication, and the UE does not support the extend DPR and is undesirable to use the extend DPR, the PH is reported in the MAC CE format of the regular DPR.

After the DPR is received by the eNodeB, the cell supports the extend DPR and the UE also supports the extend DPR, or the UE indicates that the extend DPR is used, it is considered that the DPR information is received according to the MAC CE format of the extend DPR; otherwise, the DPR information is received according to the MAC CE format of regular DPR.

### The Fourth Embodiment

Embodiments of the present disclosure also provide a storage medium. Optionally, in the embodiment, the foregoing storage medium may be configured to store program code for performing the following steps S1-S3.

In step S1, a scheduling request SR is sent to a base station.

In step S2, an uplink scheduling grant resource sent by the base station based on the SR is received.

In step S3, power headroom report PHR information is sent to the base station on the uplink scheduling grant resource.

Optionally, in an embodiment, the foregoing storage medium may include, but not limited to, a variety of media that can store program code, such as a USB flash drive, a Read-Only Memory (ROM), a Random Access Memory (RAM), a mobile hard disk, a magnetic memory or a disc.

In some embodiments, the processor executes the following steps according to the stored program code in the storage medium.

A scheduling request SR is sent to a base station.

An uplink scheduling grant resource sent by the base station based on the SR is received.

PHR information is sent to the base station on the uplink scheduling grant resource.

In some embodiments, the specific examples in this embodiment may refer to the examples described in the foregoing embodiments and the optional embodiments, and details are not described herein again.

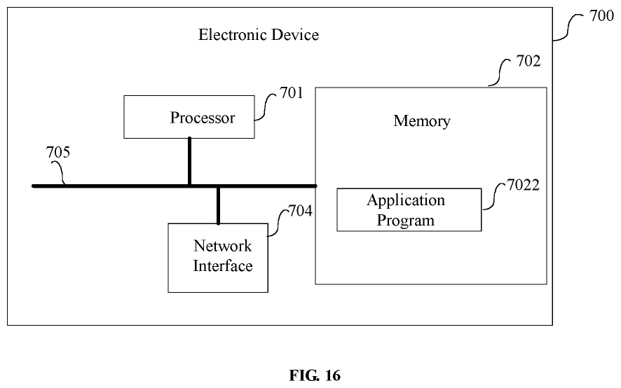

FIG. 16 is a schematic structural diagram illustrating hardware components of an electronic device (an information reporting device) based on an embodiment of the present disclosure. The electronic device 700 includes at least one processor 701, a memory 702, and at least one network interface 704. The various components in electronic device 700 are coupled together by a bus system 705. It will be appreciated that the bus system 705 is used to implement connection communication between these components. The bus system 705 includes a power bus, a control bus, and a status signal bus in addition to the data bus. However, for clarity of description, various buses are labeled as bus system 705 in FIG. 16.

The memory 702 in the embodiment of the present disclosure is used to store various types of data to support the operation of the electronic device 700. Examples of such data include any computer program, such as application program 7022, for operating on electronic device 700. A program implementing the method of the embodiment of the present disclosure may be included in the application program 7022.

The method disclosed in the foregoing embodiments of the present disclosure may be applied to the processor 701 or implemented by the processor 701. The processor 701 may be an integrated circuit chip with signal processing capabilities. In the implementation process, each step of the foregoing method may be completed by an integrated logic circuit of hardware in the processor 701 or an instruction in a form of software. The processor 701 described above may be a general purpose processor, a digital signal processor (DSP), or other programmable logic device, discrete gate or transistor logic device, discrete hardware component, or the like. The processor 701 can implement or perform the various methods, steps, and logic blocks disclosed in the embodiments of the present disclosure. A general-purpose processor can be a microprocessor or any conventional processor or the like. The steps of the method disclosed in the embodiment of the present disclosure may be directly implemented as a hardware decoding processor, or may be performed by a combination of hardware and software modules in the decoding processor. The software module can be located in a storage medium that is located in memory 702, the processor 701 reads the information in memory 702 and, in combination with its hardware, to perform the steps of the foregoing method.

In an exemplary embodiment, the electronic device 700 may be implemented by one or more Application Specific Integrated Circuits (ASICs), DSPs, Programmable Logic Devices (PLDs), and Complex Programmable Logic Devices (CPLDs), FPGA, general-purpose processor, controller, MCU, MPU, or other electronic components to perform the aforementioned methods.

It will be apparent to those skilled in the art that the various modules or steps of the present disclosure described above can be implemented by a general-purpose computing device, they may be concentrated on a single computing device, or distributed in a network constituted by a plurality of computing devices, optionally they may be realized with program codes executable by computing devices, thereby they may be stored in storage devices and executed by computing devices, in some cases, the steps shown or described may be performed in an order different than that herein, or they may be separately made into individual integrated circuit modules, or a plurality of modules or steps among them may be made into a single integrated circuit. Thus, the disclosure is not limited to any specific combination of hardware and software.

The above description is only the preferred embodiment of the present disclosure, and is not intended to limit the present disclosure, and various modifications and changes can be made to the present disclosure. Any modifications, equivalent replacements, improvements, and the like, made within the spirit and scope of the present disclosure, are intended to be included within the scope of the present disclosure.

1.-16. (canceled)

17. An information reporting method, comprising:
receiving system information sent by a base station, wherein the system information includes extend power headroom report (PHR) support indication; and
reporting extended power headroom level to the base station based on the system information.

18. The method according to claim 17, wherein the system information comprises system information block (SIB) information.

19. The method according to claim 17, wherein the reporting extended power headroom level to the base station based on the system information comprises:
reporting, when the extend PHR support indication is included in the system information and extended power headroom reporting is supported by a terminal, the extended power headroom level by using DPR media access control (MAC) control element (CE).

20. (canceled)

21. The method according to claim 17, wherein, when reporting the extended power headroom level by using the DPR MAC CE,
in the MAC CE, rightmost 4 bits being used to indicate DV, and leftmost 4 bits being used to indicate PH.

22. An information reporting method, comprising:
sending system information to a terminal, wherein the system information includes extend power headroom report (PHR) support indication; and
receiving extended power headroom level reported by the terminal based on the system information.

23. The method according to claim 22, wherein the system information comprises system information block (SIB) information.

24.-31. (canceled)

32. A terminal device, comprising a processor and a memory for storing a computer program executable on the processor, wherein the processor, when executing the computer program, is configured to:
receive system information sent by a base station, wherein the system information includes extend power headroom report (PHR) support indication; and
report extended power headroom level to the base station based on the system information.

33. The terminal device according to claim 32, wherein the system information comprises: system information block (SIB) information.

34. The terminal device according to claim 32, wherein the processor is configured to:
report, when the extend PHR support indication is included in the system information and extended power headroom reporting is supported by a terminal, the extended power headroom level by using DPR media access control (MAC) control element (CE).

35. The terminal device according to claim 32, wherein, when reporting the extended power headroom level by using the DPR MAC CE,
in the MAC CE, the rightmost 4 bits being used to indicate DV, and the leftmost 4 bits being used to indicate PH.
